(19) United States
(12) Patent Application Publication
(10) Pub. No.: US 2004/0052274 A1
(43) Pub. Date: Mar. 18, 2004

(54) Method and apparatus for allocating bandwidth on a passive optical network

(75) Inventors: Guo Qiang Wang, Kanata (CA); Larry Marcanti, Allen, TX (US); Herman Kwong, Kanata (CA)

Correspondence Address: JOHN C. GORECKI, ESQ., 165 HARVARD ST., NEWTON, MA, 02460, US

(73) Assignee: Nortel Networks Limited, St. Laurent (CA)

(21) Appl. No.: 10/316,796

(22) Filed: Dec. 11, 2002

Related U.S. Application Data
(60) Provisional application No. 60/410,861, filed on Sep. 13, 2002.

(51) Int. Cl. H04J 3/16

(52) U.S. Cl. 370/468

(57) ABSTRACT

Time cycles in the physical layer of a passive optical network may be shared by multiple transmitting network devices (ONUs) to enable transmission of time sensitive traffic in a time sensitive manner. By allocating channels within the cyclic frame structure of the physical layer of the network, transmission of data from the ONUs to the OLT may be smoothed to enhance time dependent characteristics of the network. Where the underlying physical layer is a SONET/SDH based network, each SONET/SDH frame is divided into a given number of channels, such as 125 channels each of which is 1 μS long. Each ONU is allocated one or more channels on each frame in which to transmit data to the OLT. The total bandwidth allocated to a given ONU is determined based on the number of channels allocated to that ONU.

### BACKGROUND OF THE INVENTION

1. Field of the Invention

The present invention relates to allocating bandwidth on a network and, more particularly, to a method and apparatus for allocating bandwidth between transmitting devices on a point-to-multipoint network.

2. Description of the Related Art

Data communication networks may include various computers, servers, nodes, routers, switches, hubs, proxies, and other network devices coupled to and configured to pass data to one another. These devices will be referred to herein as “network devices.” Data is communicated through the data communication network by passing data packets (or data cells or segments) between the network devices by utilizing one or more communication links between the devices. A particular packet may be handled by multiple network devices and cross multiple communication links as it travels between its source and its destination over the network.

Network devices on a communication network communicate with each other using predefined sets of rules, referred to herein as protocols. Different protocols are used to govern different aspects of the communication, such as how signals should be formed for transmission between network devices, various aspects of what the data packets should look like, and how packets should be handled or routed through the network by the network devices.

Passive optical networks are one example of point-to-multipoint networks. A Passive Optical Network (PON) is an optical network configured to use passive optical systems in the middle of the network, and active electronic optical devices, e.g. transmitters and receivers, at the network's endpoints. Typically, the network endpoints are at the central office or headend on one side, and the customer premises on the other side. In one common configuration, an optical line terminating (OLT) network device is located at the headend, and a plurality of optical network units (ONUs) are located at the customers' premises. Between the endpoints the network includes passive optical components, such as fiber optic cabling, optical couplers, passive branching components, passive optical attenuators, and optical splices.

Data transmitted in the downstream direction (from the OLT to the ONUs) in a PON is typically a broadcast to all of the ONUs. A particular ONU will monitor the broadcast transmission, select packets that identify the ONU as the intended recipient, and discard the other packets. Appropriate interleaving of packets in the downstream transmission can thus provide each ONU with appropriate levels of service.

One method of allocating bandwidth in the upstream direction is to assign each ONU a time slot during which it can transmit data to the OLT. One common physical layer protocol that may be used to allocate time slots to transmitting network devices is known as Synchronous Optical NETwork (SONET). A very similar protocol used in Europe is Synchronous Digital Hierarchy (SDH). SONET/SDH specifies a physical layer protocol in which each second is divided into 8000 time slots (each 125 μS long). These time slots are conventionally referred to as SONET/SDH frames. In a conventional PON, the SONET/SDH frames are shared among ONUs in a predetermined fashion, such as according to how much bandwidth each ONU has requested and, more typically, according to the service level agreements in place between the ONU and the network service provider.

For example, in the PON illustrated in FIG. 1, it may be possible to partition the 8000 available SONET/SDH frames into different subsets, e.g. ONU 1 gets 1000 frames, ONU2 gets 3000 frames, ONU3 gets 30 frames, etc., such that the total number of frames shared by all ONUs adds up to 8000 frames.

Each ONU is able to transmit a given amount of information during its allocated frame. The format of the data to be transmitted will depend on the transport protocol in use on the network. For example, in a PON using SONET/SDH at the physical layer and ATM at the transport layer (ATM over SONET/SDH), a given ONU is allowed to transmit a certain number of ATM cells in each allocated SONET/SDH frame. Similarly, in a PON using SONET/SDH at the physical layer and Ethernet at the transport layer (Ethernet over SONET/SDH), a given ONU is allowed to transmit a certain number of Ethernet frames in each allocated SONET/SDH frame.

Certain types of network traffic, such as voice and video, are time sensitive and require a relatively constant bandwidth. Allocating each ONU one or more SONET/SDH frames, each of which has a duration of 125 μS, can result in an unacceptably large pause between transmissions, thus degrading the quality of the voice or video transmission. For example, if there are two ONUs transmitting on a PON, each of which are allocated half of the available SONET/SDH frames, each ONU will need to wait at least 125 μsec between transmissions. If there are 25 or more ONUs contending for bandwidth to the OLT, as is more typical on a PON, each ONU may need to wait milliseconds between transmissions.

Additionally, for relatively low bandwidth ONUs, the delay between transmission periods gets even worse. For example, assume that an ONU has a 1 Mbps contract with the OLU and that the transport between the ONU and OLT has a data rate of 1 Gbps. The OLU would, according to ONU's service level agreement, allocate 1/1000^{th} of the 8000 available frames to the ONU and enable the ONU to transmit data on those 8 frames. Even if the 8 frames are spaced equally apart, the ONU will only be allowed to transmit data every 0.125 seconds. For time sensitive traffic, such as voice traffic and video traffic, this transmission scheme may prove to be wholly unacceptable.

### SUMMARY OF THE INVENTION

The present invention overcomes these and other drawbacks by providing an method and apparatus for allocating resources on a point-to-multipoint network such that transmitting network devices are able to transmit time sensitive data in a time-sensitive manner regardless of limitations imposed by the underlying physical layer technology. Specifically, according to one embodiment of the invention, time cycles of the physical layer are subdivided into a plurality of channels, and each ONU is allowed to transmit data in one or more channels during the physical layer time cycle. By cyclically allowing ONUs to transmit data within channels in each time cycle, the ONUs are guaranteed to have at least some bandwidth during every time cycle and are not forced to store data and transmit information for an entire time cycle.

In one embodiment, the physical layer technology is SONET/SDH and the time cycles are 125 μS long to correspond with a SONET/SDH frame. Each SONET/SDH frame is subdivided into 125-1 μS channels, and each ONU is allocated one or more channels for data transmission to the OLT. In this manner, each ONU can transmit data during each SONET/SDH frame regardless of the amount of bandwidth allocated to that particular ONU. Thus, time-sensitive traffic may be transmitted over the SONET/SDH network regardless of the quantity of bandwidth purchased by a given ONU. This allows an ONU carrying voice traffic to maintain a 125 μS synchronous environment specified by legacy voice applications and reduces signal jitter.

According to another embodiment of the invention, SONET/SDH frames are not allocated solely to one ONU, but rather are shared by all ONUs. Each ONU, in this embodiment of the invention, has the opportunity to transmit data in each SONET/SDH frame. The amount of data a particular ONU can transmit in the SONET/SDH frame is based on the particular ONU's requirements and service level agreement. By enabling each ONU to transmit data during each SONET/SDH frame, ONUs with low transmission requirements are able to transmit time-sensitive traffic over the SONET/SDH network.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a passive optical network according to one embodiment of the invention;

FIG. 2 is a timeline illustrating an example of a transmission cycle that has been divided into transmission channels;

FIGS. 3-7 are timelines illustrating allocation of transmission channels to ONUs;

FIG. 8 is an ONU according to an embodiment of the invention; and

FIG. 9 is an OLT according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

As described in greater detail below, the method and apparatus of the present invention enables time cycles in the physical layer of the network to be shared by multiple transmitting network devices. By allocating channels within the cyclic frame structure of the physical layer of the network, transmission of data from the ONUs to the OLT may be smoothed to enhance time dependent characteristics of the network. Where the underlying physical layer is a SONET/SDH based network, each SONET/SDH frame is divided into channels, and each ONU is able to transmit data to the OLT on one or more channels. This enables each ONU to transmit data during each 125 μS frame. The total bandwidth allocated to a given ONU is determined based on the number of channels allocated to that ONU.

In the following description, the cycle time will be based on the SONET/SDH standard which specifies that, at the physical layer, data will be transmitted in 8000-125 μS frames per second. The invention is not limited to a cycle that is 125 μS long, however, as cycles of other lengths may be used as well. The length of the cycle should be selected, however, to allow each ONU to transmit data sufficiently frequently to avoid transmission problems for time sensitive traffic. Additionally, in the invention discussed below, the channels are discussed as being 1 μS long. The invention is not limited in this regard as the channels may be of any suitable length and need not all be of the same size. For example, a given 125 μS cycle could be split into a number of 10 μS channels, a number of 5 μS channels, a number of 1 μS channels, and a number of fractional μS channels, with the total number of channels equaling the 125 μS cycle. A passive optical network configured to implement channels will be referred to as a channelized passive optical network (CPON).

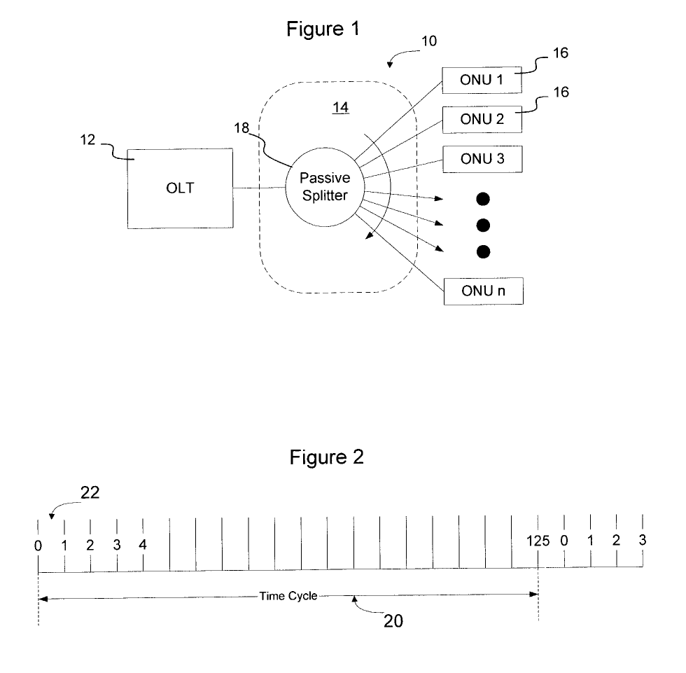

FIG. 1 illustrates a functional block diagram of a point-to-multipoint network according to an embodiment of the invention. The network of FIG. 1 may be a passive optical network, as illustrated, or may contain active components interspersed between the OLT and ONUs, such as optical amplifiers, etc., to allow the OLT and ONUs to sit at greater relative distances from each other. Although the invention will be described in connection with a passive optical network, the invention is not limited to being implemented on passive optical networks.

In the embodiment shown in FIG. 1, a network 10 has an OLT 12 connected through a passive optical network 14 to multiple ONUs 16. A passive optical splitter 18 and/or other passive optical components are used to split optical signals transmitted in the downstream direction from the OLT to the ONUs and to join optical signals transmitted in the upstream direction from the ONUs to the OLT.

FIG. 2 illustrates a timeline of an example of how the ONUs may communicate with the OLT to ensure each ONU has the ability to transmit data during each cycle of the physical layer of the network. A shown in FIG. 2, each time cycle of the physical layer 20 is subdivided into multiple time slots 22 (referred to herein as channels). In the example illustrated in FIG. 2 there are 125 channels. Channel 1 extends from time T0 to time T1, channel 2 extends from time T1 to time T2, etc. These channels may be allocated to ONUs to enable each ONU to transmit data during each cycle.

In the embodiment illustrated in FIG. 2, each channel is of equal bandwidth. The invention is not limited in this regard, however, as the channels may be determined according to any desired scheme. For example, it may be desirable under certain circumstances to have a first set of channels a first size, and a second set of channels a second size. Using two different size channels may make it possible to more easily allocate the proper amount of bandwidth to transmitting ONUs. The invention is therefore not limited to embodiments utilizing channels of equal size. However, to facilitate understanding and for ease of explanation, the remainder of the description will focus on utilization of channels of equal size.

In the example illustrated in FIG. 2, each time cycle 20 is divided into 125 channels, each of which is 1 μS long. If the transmission rate over the optical fiber is 1 Gbps, each 1 μS long channel will enable an ONU to transmit 1000 bits of data. Since there are 8000 cycles per second, each channel will enable an ONU to transmit 8 Mbps.

Allocating one or more channels to an ONU can allow the ONU to transmit data according to many conventional data rates. For example, assume that an ONU would like to transmit at the DS1 data rate (1.544 Mbps). If the cycles are 125 μS long and each cycle is broken into 125 channels, the ONU will need to transmit 192+1 extra bits per 125 μS cycle. If the transport layer protocol is Ethernet, the ONU will add an Ethernet header (approximately 200 bits) to the 193 bits of data for a total packet size of about 400 bits. Taking the minimum Ethernet packet size into account (26 header bytes and 46 payload bytes), the total packet size will be 576 bits. Since the ONU is able to transmit 1000 bits per channel (as discussed above), the ONU will be able to transmit data at the conventional DS1 data rate by utilizing a single channel. In between transmission cycles the ONU will receive and buffer traffic for transmission during the next cycle.

As another example, assume that the ONU would like to transmit data at the conventional STS1 data rate (51.84 Mbps). In this example the ONU will need to transmit 6480 bits per cycle (6480 bits per cycle×8000 cycles=51.84 Mbps). Adding overhead to this (Ethernet overhead=200 bits per frame, the ONU will need seven channels to achieve this data rate. Viewed differently, if every channel is viewed as an 8 Mbps channel, then an STS 1 will need seven 8 Mbps channels to achieve 51 Mbps.

Channelized Passive Optical Networks (CPONs) will support next generation SONET/SDH protocols. Specifically, next generation SONET/SDS network devices typically implement three new protocols: Generic Framing Protocol (GFP), Virtual Concatenation (VC) and Link Capacity Adjustment Scheme (LCAS). The manner in which these protocols may be deployed within a CPON will now be discussed in connection with FIG. 2.

The first part of next generation SONET/SDH is Virtual concatenation (VC). VC enables data traffic to be transported over right-sized tributaries instead of matching data services into a certain limited set of tributaries, as was done initially with SONET/SDH. Specifically, the original SONET standard required data traffic to be transported over tributaries sized as a STS-1, STS3c or STS12. Using VC, individual STS-1 sized flows can be concatenated to form, e.g., an STS-7 sized tributary.

There are two types of VC: Low Order VC (LO VC) and High Order VC (HO VC). LO VC enables concatenation of Virtual Tributaries (VTs), which are smaller capacity channels than an STS-1 in SONET or STM-1 in SDH. HO-VC specifies concatenation of tributaries that are STS-1 or higher. The ability to provide variable bandwidth capacity links in the network is very important for supporting Ethernet and other packet services in the metropolitan area network and wide area network space, which can have varying service level agreements.

Using channels formed from time slots in transmission cycles, as discussed above, it is possible to transmit data at any desired transmission rate. Specifically, assume for example that an ONU would like to transport data to the OLT at an STS-2c data rate (100 Mbps). To accomplish this, the ONU will simply request and have allocated 13 channels. 13 channels provides the ONU with 104 Mbps of bandwidth, which is sufficient, given anticipated overhead considerations, to transport at the required STS-2c data rate. Thus, using channels formed from time slots in transmission cycles of the physical layer according to embodiments of the invention will support HO-VC. Additionally, as discussed above CPON can support LO-VC by allocating one or another small number of channels to an ONU. Thus, the CPON architecture according to the invention can support Virtual Concatenation.

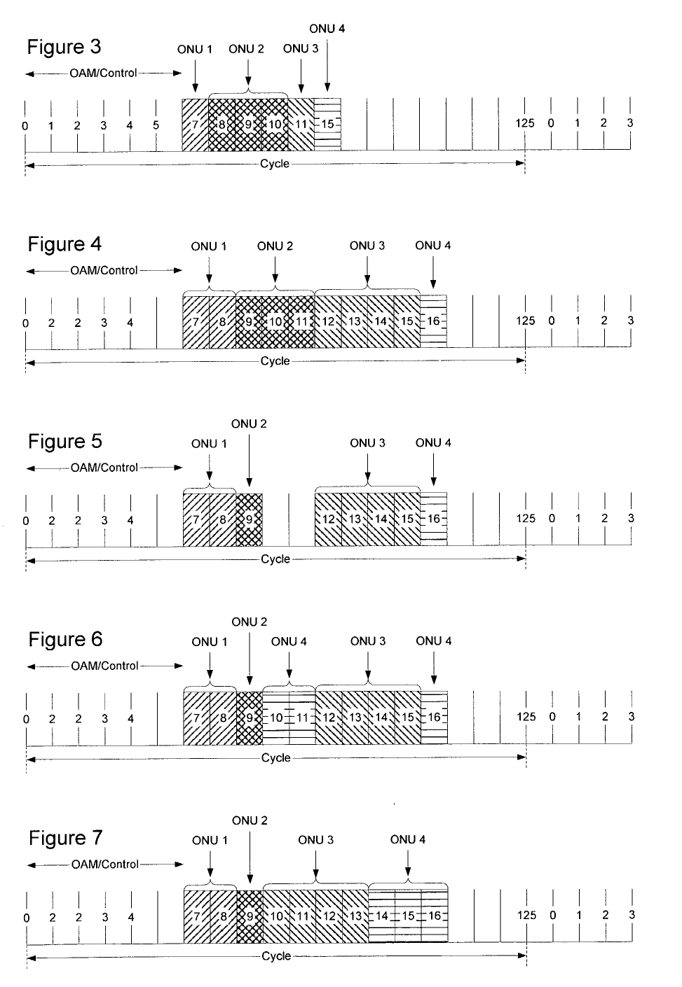

The second part of next generation SONET/SDH is Link Capacity Adjustment Scheme (LCAS). LCAS supplements Virtual Concatenation by allowing the capacity of the transport channel to be adjusted in real time. LCAS provides the ability to dynamically provision additional transport paths on an existing transport facility for new services in an existing network without service disruption or requiring pre-established reservation. It also enables the basic protocols to be enhanced by enabling dynamic bandwidth management in real time based on offered load. Through dynamic channel allocation between ONUs, it is possible to implement LCAS on the CPON architecture. Dynamic channel allocation will be discussed in greater detail below in connection with FIGS. 3-7.

The third part of next generation SONET/SDH is Generic Framing Protocol (GFP). GFP provides an efficient and protocol-agnostic frame delineation and encapsulation mechanism that will allow a variety of protocols to be transported over SONET/SDH networks. There are currently two ratified ITU-T GFP standards: frame-mapped and transparent. Frame-mapped GFP is used for encapsulating datagram-based protocols like Ethernet and Internet Protocol (IP). Transparent GFP is applicable for block-coded protocols like Fiber Channel and Enterprise Systems Connection (ESCON).

GFP allows multiple physical ports to be multiplexed into a single transport path through the network. Frame-mapped GFP allows rate adaptation and aggregation of multiple packet streams into a single SONET/SDH tributary, while transparent GPF allows for native transport of all block-coded protocol traffic over TDM tributaries, regardless of whether the traffic is packet oriented or not. Neither of these versions of GFP should be impacted by using channels to allocate bandwidth over the SONET/SDH network.

### Synchronization and Control

To allow ONUs to transmit data in channels within a given cycle, it is necessary to allocate channels to the ONUs so that they know when to transmit data, and to synchronize the ONUs to avoid transmission collisions. This requires certain information to be transmitted from the OLT to the ONUs and, in certain circumstances, may require feedback from the ONUs.

In one embodiment, one or more channels in the upstream transmission direction are used to exchange synchronization information and to provide other Control and Operation, Administration, and Maintenance (OAM) functions. For example, in the embodiment illustrated in FIGS. 3-7, the first six time slots are allocated to OAM/Control. If more than six ONUs are communicating with the OLT, the ONUs will need to share these six channels according to a predetermined arrangement, to prevent data collisions from occurring.

According to one embodiment, the ONUs are allowed to transmit control, synchronization, and other information to the OLT during one or more of the OAM/Control channels on a round-robin basis. Thus, for example, during the first cycle ONU 1 may be allocated OAM/Control channels 1-3 and ONU 2 may be allocated OAM/Control channels 4-6. In the next cycle ONU 3 may be allocated OAM/Control channels 1-3 and ONU 4 may be allocated OAM/Control channels 4-6. The ONUs may share the OAM/Control channels in any convenient manner and the invention is not limited to any particular manner of dividing the control channels between the ONUs.

The ONUs may utilize the OAM/Control channels to transmit requests for additional bandwidth to the OLT. For example, in FIG. 3, ONU1 has been allocated 1 channel (channel 7), ONU 2 has been allocated three channels (channels 8-10), ONU 3 has been allocated 1 channel (channel 11) and ONU 4 has been allocated 1 channel (channel 15). Assume for this example that ONUs 1 and 3 would like additional bandwidth. Utilizing the OAM/Control channels, ONU 1 and ONU 3 may request additional channels. The OLT, upon receiving the request, will allocate additional channels to ONU 1 and ONU 3 and re-allocate channels to the transmitting ONUs. This may be done in a OAM/Control channel in the downstream flow from the OLT to the ONUs or via OAM/Control packets broadcast to the ONUs. Upon receipt of the new channel allocation, the ONUs will transmit data in their new channel allotment.

FIG. 4 illustrates the new channel allotment from this example. Specifically, as shown in FIG. 4, ONU1 has now been allocated 2 channels (channel 7 and 8), ONU 2 has not had its allocation changed and has still been allocated three channels. However, to allow ONU 1 to have contiguous channels, ONU now has been allocated channels 9-11. ONU 3, in this example, requested four channels. Accordingly, ONU 3 has been allocated channels 12-15. ONU4 has maintained its previous channel allotment and has now been assigned channel 16.

The OLT may respond that there is insufficient bandwidth to allow a particular ONU to increase its bandwidth. Alternatively, the OLT may have over-allocated bandwidth to other ONUs to enable them to transmit more data than their committed information rate. In this instance it may be desirable to reduce the number of time slots provided to one or more of the ONUs. By using the OAM/Control packets or channels on the downstream flow, the OLT may adjust the bandwidth of each ONU to enable ONUs to exceed their committed information rate in instances of low network utilization, and to constrain the ONUs during periods of high network utilization.

It certain circumstances, one or more ONUs may wish to relinquish one or more of its channels. This may be desirable from an ONU standpoint, for example, where the ONU is charged on a per channel per cycle basis. FIG. 5 illustrates an example in which ONU 2 has relinquished 2 of 3 channels and now is only allocated channel 9.

The OLT may reallocate the channels to other ONUs in any number of ways. For example, as illustrated in FIG. 6, the OLT may simply allocate the relinquished channels 10 and 11 to other ONUs. In the embodiment illustrated in FIG. 6, assume that ONU 4 has requested additional bandwidth equal to the two channels being relinquished by ONU 2. In this embodiment, the OLT may allocate channels 10 and 11 to ONU 4 to fulfill ONU 4's request for additional bandwidth.

It may be desirable, in certain circumstances, to allocate contiguous channels to ONUs to eliminate overhead. Specifically, at the beginning of each channel a given ONU may need to transmit packet header information. Additionally, as discussed in greater detail below, it may be necessary for ONUs to stop transmitting data a small amount of time prior to the end of the time slot forming the channel to prevent collisions due to imprecise synchronization between the ONUs. In these, and probably other, circumstances, it may be desirable to allocate channels to ONUs to allow some, most, or all of the ONUs are able to transmit its data on a set of contiguous channels.

FIG. 7 illustrates an example in which the bandwidth relinquished by ONU is reallocated to ONU 4 by redistributing channel allocation between the ONUs. As shown in FIG. 7, ONU 1 in this example has continued to have two allocated channels (channels 7 and 8), and ONU 2 has one allocated channel (channel 9). ONU 3 has four allocated channels and has not had its bandwidth diminished. ONU 3 has now been instructed, however, to transmit data on channels 10-13 instead of channels 12-15. ONU 4, in this embodiment, is provided with the increased bandwidth it requested, and has been instructed to transmit data on channels 14-16.

By allocating bandwidth on a channel basis, it is possible to ensure quality of service (QoS) to ONUs. Specifically, each ONU is guaranteed to have at least some bandwidth during each cycle of the physical layer in which it can transmit data. By dynamically adjusting the bandwidth of the ONUs through channel allocation, the OLT can tailor traffic in any number of desired ways.

One way of allocating channels to the ONUs for upstream communication is to include channel allocation information in an OAM/Control packet addressed to the ONUs. This may be done on a cyclic basis by dedicating a similar OAM/Control channel in the downstream flow, or may be implemented using standard control packets. In one embodiment, the OLT allocates channels on a per-cycle basis using a table or other suitable data format to indicate to the ONUs which channels they should use to transmit data. An example of the channel allocation is set forth in Table 1.

TABLE I

| ONU ID | Channel numbers |
|---|---|
| OAM/Control | 1-6 |
| ONU 1 | 7 |
| ONU 2 | 8-10 |
| ONU 3 | 11-12 |
| ONU 4 | 13 |
| * * * | * * * |
| ONU N | 121-125 |

Channel allocation can take into account the type of traffic to be transmitted by each ONU as well as the service level agreements in effect for each ONU. Thus, the ONUs may transmit requests for additional bandwidth to the OLT and include, in that request, the type of traffic to be transmitted on the channels. The OLT may use this traffic information to prioritize traffic to enable high priority traffic to displace lower priority traffic. There are many schemes for prioritizing traffic depending on the particular protocol in use, and the invention is not limited to any particular protocol or manner of prioritizing traffic. Accordingly, regardless of the traffic prioritization scheme utilized by the ONUs, the prioritization information may be passed to the OLT and the OLT may use this information, alone or in combination with SLA information, to enforce policies and allocate bandwidth in a preferential manner to higher priority traffic.

Channel handoff between ONUs will require the ONUs to be synchronized so that broadcasting ONUs do not inadvertently overrun their allocated channel broadcast time. Through the use of OAM/Control packets from the OLT, alone or in combination with feedback from the ONU, the ONUs should be able to be synchronized to transmit mainly within their timeslot. To handle minor synchronization errors, in one embodiment of the invention, an ONU is instructed to stop transmitting a fraction of the channel length before relinquishing transmission to another ONU. For example, if each channel is 1 μS long, the ONU may be required to stop sending data 0.1 μS or 0.2 μS before the end of its last channel for that transmission session. This synchronization buffer should eliminate a majority of conflicts when handing off transmission between ONUs.

There is no need to enforce a channel synchronization buffer between channels allocated to the same ONU since there is no chance that the ONU will have a collision with its own data. Thus, for example in FIG. 3, ONU 2 would be allowed to use all of channels 8 and 9. To avoid a potential collision with transmissions from ONU 3 in channel 11, in one embodiment ONU 2 would need to stop transmitting data fraction of the channel length before the end of channel 10.

The CPON architecture may be used in a variety of ways to enhance the security of the network. For example, channel allocation may be changed on a per cycle or every few cycles according to pre-shared patterns or in connection with real-time OAM/Control information from the OLT. By securing the OAM/Control communication channel with the ONUs, only the particular ONU that is to be transmitting will know the identity of the channel that it will use. By varying the channel number every cycle or every few cycles, it may become very difficult for a casual listening device to obtain a coherent picture of the transmission emanating from a particular ONU.

In one embodiment, the CPON architecture is implemented in a wireless data access environment, such that the OLT in FIG. 1 is a base station and each of the ONUs is a Mobile Operating Center (MOC) having hardware and/or software configured to broadcast signals to mobile telephones, mobile computers, and other mobile telecommunications devices. Implementing the CPON architecture in this environment enables each of the MOCs to receive data and transmit data to the base station over a passive optical network, thus enabling the wireless data access network to take advantage of the reduced costs and simplified network architecture discussed above. Although the invention may be advantageously employed in a wireless data access network, the invention is not limited to being deployed in this environment.

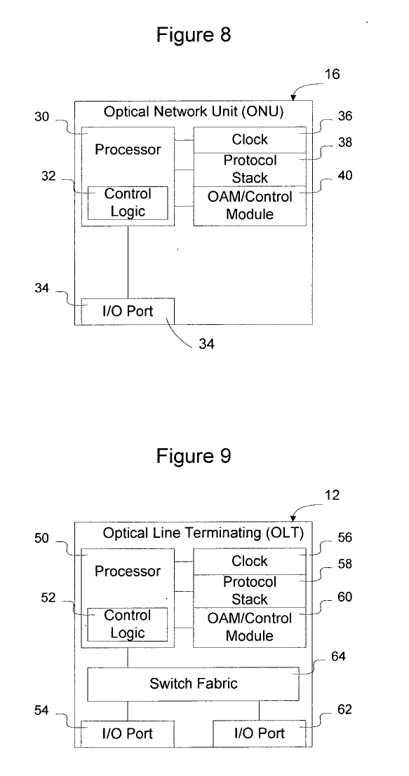

FIG. 8 illustrates an optical networking unit (ONU) 16 according to an embodiment of the invention. As shown in FIG. 8, the ONU 16 includes a processor 30 and control logic 32 configured to implement the functions ascribed to the ONU as described above in connection with FIGS. 1-7. One or more I/O ports 34 are provided to enable the ONU 16 to send and receive signals from the network. In the illustrated embodiment only one set of I/O ports has been illustrated to prevent obfuscation of the inventive aspects of the invention. The invention is not limited to a network device having a single I/O port or a single set of I/O ports, as a network device may have any number of I/O ports.

The ONU 16 also includes functional modules containing data or instructions for use by the control logic to enable it to perform the functions required of it to participate in communicating over a channelized passive optical network with an OLT 12. Specifically, in the illustrated embodiment, the ONU 16 includes a protocol stack 36, a clock 38, and an operation, administration and maintenance (OAM/Control) module 40. The protocol stack provides the ONU 16 with data and instructions to enable it to participate in transmitting data over the network. The clock 38 enables the ONU 16 to maintain synchronization with other network devices, such as other ONUs and the OLT, so that the ONU is able to transmit data in the allocated channels. The OAM/Control module enables the ONU to receive OAM/Control information, to provide feedback to the OLT, and to request or cede bandwidth on the network.

FIG. 9 illustrates an optical line terminating network device (OLT) 12 according to an embodiment of the invention. As shown in FIG. 9, the OLT 12 includes a processor 50 and control logic 52 configured to implement the functions ascribed to the OLT as described above in connection with FIGS. 1-7. The OLT also includes I/O ports 54, a clock 56, a protocol stack 58, and an OAM/Control module 60 in much the same way as ONU 16. The OLT 12 further includes a second set of I/O ports 62 to transmit data received from the ONUs onto the network. Optionally, a switch fabric 64 may be provided to optimize handling of packets passing through the OLT 12.

The control logic 32 of ONU 16 and control logic 52 of OLT 12 may be implemented as a set of program instructions that are stored in a computer readable memory within the network device and executed on a microprocessor within the network device. However, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

Accordingly, while the invention has been described largely in a SONET/SDH context, the invention is not limited to use in a SONET/SDH network but rather extends to other networks having a physical layer transmission protocol divided into transmission cycles.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of allocating bandwidth on a network, the method comprising the steps of:
subdividing physical layer protocol cycles into a plurality of channels, said channels being time slots within the physical layer protocol cycle; and
allocating channels to transmitting network devices such that each transmitting network device with an allocated channel is allowed to transmit data during each physical layer protocol cycle.

2. The method of claim 1, wherein the physical layer protocol is at least one of SONET and SDH.

3. The method of claim 1, wherein the channels are in the same order during each cycle.

4. The method of claim 1, further comprising the step of receiving requests for additional bandwidth from a particular transmitting network device.

5. The method of claim 4, further comprising the step of allocating additional bandwidth to the particular transmitting network device.

6. The method of claim 1, wherein the network is a passive optical network.

7. The method of claim 1, further comprising the step of receiving requests to reduce an amount of allocated bandwidth from a particular transmitting network device.

8. The method of claim 7, further comprising the step of reducing the amount of allocated bandwidth to the particular transmitting network device.

9. The method of claim 1, further comprising the step of adjusting an allocation of channels between transmitting network devices so that transmitting network devices with more than one channel have contiguous channels.

10. The method of claim 1, further comprising the step of distributing synchronization information to the transmitting network devices.

11. The method of claim 1, wherein the network is a wireless data access network, and wherein the transmitting network devices are mobile operating centers.

12. An optical line terminating (OLT) network device configured to communicate with optical network units (ONUs) over a passive optical network, said optical line terminating network device, comprising:
subdivide physical layer protocol cycles into a plurality of channels, said channels being time slots within the physical layer protocol cycle; and
allocate channels to ONUs such that each ONU with an allocated channel is allowed to transmit data during each physical layer protocol cycle.

13. The OLT of claim 12, further comprising a switch fabric configured to receive packets of data from the ONUs, interleave the packets of data from multiple ONUs, and transmit the interleaved packets onto a second network.

14. The OLT of claim 12, wherein the physical layer protocol is at least one of SONET and SDH.

15. The OLT of claim 12, further comprising a clock module configured to synchronize transmissions between the OLT and ONUs.

16. The OLT of claim 12, further comprising a protocol stack configured to implement protocol exchanges between the OLT and ONUs.

17. The OLT of claim 12, further comprising an OAM/Control module configured to receive requests for additional bandwidth from a requesting ONU and allocate additional channels to the requesting ONU.

18. The OLT of claim 12, further comprising an OAM/Control module configured to receive requests for reduced bandwidth from a requesting ONU and allocate a reduced number of channels to the requesting ONU.

19. An optical network unit (ONU) configured to transmit data packets over one or more allocated channels in a cycle of a physical layer protocol, each said channel being formed of a time slot in said cycle, the ONU comprising:
an I/O port for transmitting data; and
control logic configured to synchronize transmission of said data packets with occurrence of said one or more allocated channels.

20. The ONU of claim 19, further comprising an OAM/Control module configured to request additional channels and request a reduced number of channels.

21. The ONU of claim 19, further comprising a clock module configured to provide timing information to said control logic.

22. The ONU of claim 19, wherein the ONU is a mobile operating center, and wherein the ONU further comprises at least one of hardware and software configured to broadcast signals to at least one of a mobile telephone, a mobile computer, and a mobile telecommunications device.
